(19) United States
(12) Patent Application Publication
(10) Pub. No.: US 2007/0227644 A1
(43) Pub. Date: Oct. 4, 2007

(54) Wiring and Method for Instrumentation of a Tire or an Antivibration Hinge or a Safety Support for a Vehicle Ground Contact System

(76) Inventors: Lionel Fagot-Revurat, Ussel De Vensat (FR); Patrick Gougnaud, Saint-Vincent (FR); Valery Poulbot, Les Martres D'Artiene (FR); Michel Robert, Cellule (FR)

Correspondence Address: COHEN, PONTANI, LIEBERMAN & PAVANE, 551 FIFTH AVENUE, SUITE 1210, NEW YORK, NY, 10176, US

(21) Appl. No.: 11/596,454

(22) PCT Filed: May 12, 2005
(86) PCT No.: PCT/EP05/52161

§ 371 Date: Nov. 13, 2006

(30) Foreign Application Priority Data
May 13, 2004 (FR) 0405193

(51) Int. Cl. B60C 19/00

(52) U.S. Cl. 156/110.1; 152/152.1

(57) ABSTRACT

Instrumentation for a rubber article for the ground contact system of a vehicle, such as an anti-vibration coupling or a tire, may comprise the use of wiring (34) for electrical connection between functional units (36, 38). A connecting element having wiring (34), or an electrical harness, integrated into a support (32) of precured elastomer compatible with the rubbers of the tire. The electrical connecting element may constitute part of an overall instrumentation complex (30), which comprises functional units (36, 38), connections (34) and other accessories (40, 42) necessary for instrumentation of the tire, integrated into the support (32), the complex (30) being so shaped as to be capable of being affixed to the tire casing prior to vulcanization.

### FIELD OF THE INVENTION

The invention relates to the field of instrumentation of the deformable articles used in the ground contact system of a vehicle.

More particularly, the invention relates to the electrical wiring necessary for full instrumentation of such a deformable article and integration thereof so as not to impair the mechanical properties of said article for a vehicle ground contact system.

### BACKGROUND OF THE INVENTION

The instrumentation of tires aims to integrate therein electronic devices, such as sensors, in order for example to ensure monitoring of parameters relating to tire use and/or wear.

It has thus been envisaged to integrate a sensor into the rubber of the tire, despite its undergoing considerable deformation during both manufacture and use thereof. Furthermore, such electronic devices must also comprise means for powering the sensors and retrieving the signals, or even processing them. In particular, the solutions described in the prior art propose sensors which are as small as possible, for example of the nail type (see document EP-A-1,275,949), coupled to a, frequently electromagnetic, receiving antenna. These antennas take the form of an electrical conductor forming a closed loop, which may extend over the entire circumference of the tire: see documents WO 99/29522 or WO 99/29495. To withstand deformation of the rubber of the tire in which they are embedded, the loops are configured so as to be able to undergo elongation, the conducting wire being arranged in a zigzag formation, for example; furthermore, the wire is sometimes associated with an elastomeric coating. However, no document mentions the problem stemming from shear between the, rigid, conductor and the polymer surrounding it.

Tire instrumentation remains an accessory, and it is clear that the main function of the assembly obtained continues to be to ensure the best travel conditions. In particular, it is important that the various devices integrated into the tire do not impair either its mechanical performance or its durability.

Furthermore, direct transmission of the signal picked up by the antenna is sometimes undesirable. The presence of a sensor in effect modifies the environment within which the measurement is performed, and the sensors of the nail type do not constitute a solution with regard to certain parameters: it sometimes seems to be necessary to relocate the processing electronics of the sensor proper, in order to disturb as little as possible the measurement environment and to obtain a more reliable parameter. On the other hand, the parameter cannot always be transmitted in the unprocessed state and may require local processing. A solution proposed by document EP-A-1,350,640 suggests positioning electrical connections radially through the rubber, in holes then filled with an elastomer, towards a processing unit attached to the tire. Even if this positioning actually subjects the electrical wire to few stresses, no indication is made as to the long-term performance of this type of connection. Furthermore, the instrumentation configurations and the position of the sensors are very limited in this case, the manufacturing process is long, and tire alteration may become significant if it is envisaged to position a multitude of sensors.

Thus, in the case where the parameter is measured at different places requiring the presence of a plurality of separate sensors, or indeed sensors distributed uniformly around the circumference of the tire, an electrical connection between sensors and processing unit is necessary. For the sake of reliability, it becomes desirable for said processing unit also to be located in the tire.

However, such connections pose problems stemming from the fact that the electrical connecting wires are by nature inextensible, whereas the rubber of the tire is elastic and subject to severe mechanical stress during use, with considerable deformation. In particular, the existing ribbon cables used for this type of electronic connection are unsuitable: the insulating material forming the support does not adhere directly to the tire and the wires lose their integrity.

### SUMMARY OF THE INVENTION

The invention aims, among other advantages, to overcome the drawbacks mentioned above, and proposes in particular to integrate electronic devices in a manner which respects the intrinsic mechanical properties of a deformable article used in the ground contact system of a vehicle, the latter covering in the present specification an anti-vibration coupling or a tire or a safety support mounted inside a tire, such as a support mounted inside a PAX System sold in particular by Michelin.

It should be pointed out, for the purpose of information, that in the context of the present invention the term “tire” applies equally to an inflatable tire and a elastic solid tire or a caterpillar track, all of these terms being interpreted as equivalent: the context of the invention aims to provide means making it possible to turn these rubber articles into communicating instrumented objects.

More particularly, the invention proposes to increase instrumentation possibilities by forming electrical connections invisible from the mechanical point of view between different integrated elements, and putting in place preformed electronic complexes.

In one of its aspects, the invention relates to an electrical connecting element capable of being attached to a deformable article used for the ground contact system of a vehicle, during manufacture thereof and before vulcanization thereof. The connecting element comprises an electrical harness, or wiring, composed of at least one electrical wire, preferably a plurality thereof, which may take mutually parallel courses and of which each end may be connected to a different functional unit, the wires thus ensuring a galvanic connection; spacing between the functional units may range from a few millimeters, for example in the case of a piezoelectric sensor whose signal is weak, to more than ten centimeters, for example in the case where two sensors which are diametrically opposed relative to the tire are connected to the same processing unit. The electrical wires may be wires of brass-coated steel similar in nature to the reinforcements already used in tire structures. The harness is integrated into a support in accordance with a predetermined geometry such that it withstands tensile forces exerted on the support without breaking or undergoing relative displacement at the level of the interface with regard to the support surrounding it. The support is composed of a pre-crosslinked, preferably insulating, elastomer, which is compatible with the mixes conventionally used in the field of tires. “Compatible” should be understood to mean that, when the mix and the elastomer are juxtaposed, the vulcanization stage ensures an intimate bond.

Advantageously, the functional units used for instrumentation are themselves also at least partially integrated into the support. In this regard, the invention relates in one of its aspects to an instrumentation complex comprising at least one functional unit connected to the electrical harness, and preferably comprising all the electronics integrated into the tire, or more generally the rubber article, for instrumentation thereof. The complex may thus comprise a processing unit optionally associated with a control unit, which is connected by wiring to at least one sensor and/or actuator. It may also comprise antennas.

In one of the preferred embodiments, the thickness of the support of the electrical connecting element and/or of the instrumentation complex is small, of the order of one millimeter, such that said entity may be set in place during assembly of a tire blank for example without really modifying the tire manufacturing process.

In another aspect, the invention relates to a process for manufacturing an instrumented rubber article for the ground contact system of a vehicle such as an instrumented tire, that is to say for integrating electronic components and their electrical connections into such an article.

A conventional process for building a tire consists in assembling the various constituents of the tire, often semi-finished products, by laying them in a predetermined order to produce a tire blank. The process according to the invention provides for an electrical connecting element and/or an instrumentation complex as defined above to be set in place during assembly. According to one preferred embodiment, a shaping stage is provided during assembly, before or after the instrumentation has been set in place. In this latter case, the electrical harness is such that no displacement occurs between the surface of the electrical wires and the surface of the adjacent support both during use of the tire and during this stage.

These stages are followed by vulcanization of the assembled whole; during vulcanization, the elastomer chains of the support and of the rubber surrounding it become interwoven so as to form a unitary compound, that is to say that crosslinking is intimate between the two constituents.

The invention finally relates to a deformable article used for the ground contact system of a vehicle such as a tire, comprising electrical wiring which is integrated in such a way that the electrical wires do not undergo any relative displacement with regard to the polymeric material constituting the tire at the level of the interface. Advantageously, the wires are associated with the functional units constituting the tire instrumentation, and the rubber adjacent to these elements is insulating.

### BRIEF DESCRIPTION OF THE DRAWINGS

Other features and advantages of the invention will be revealed more clearly on reading the following description, which relates only to tires, without this being limiting, and is made with reference to the appended drawings, which are given solely by way of illustration and are in no way limiting.

FIG. 1 is a schematic, sectional representation of a tire.

FIG. 2 shows conventional tire instrumentation.

FIG. 3 shows examples of electrical connecting elements according to the invention.

FIG. 4 shows an embodiment of an instrumentation complex according to the invention.

### DETAILED DESCRIPTION OF PARTICULAR EMBODIMENTS

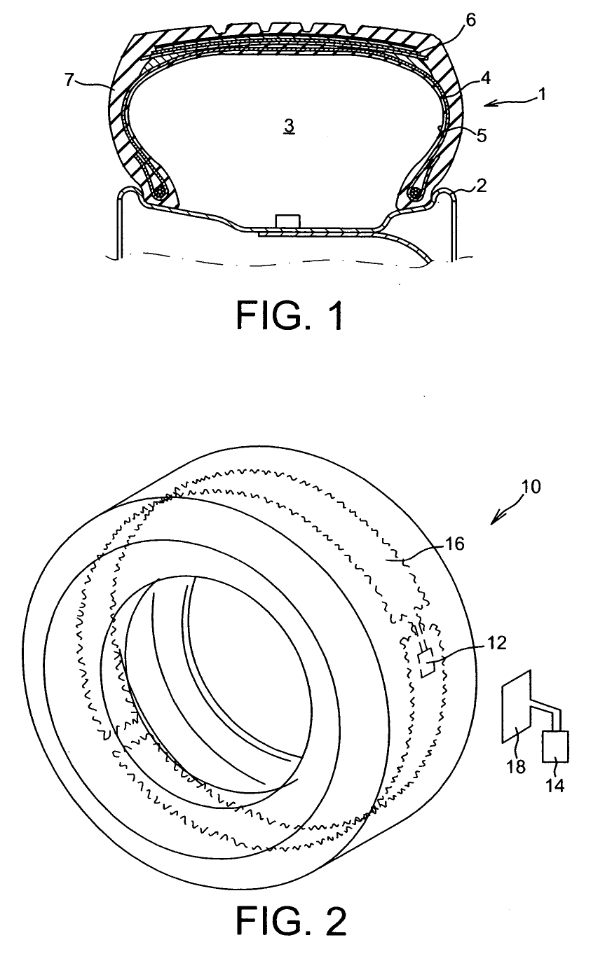

FIG. 1 shows a radial section through a known tire 1, which defines with the rim 2 a volume 3 filled with air. The tire 1 is made up of numerous different assembled layers. During conventional tire manufacture, for example, a carcass 4 is formed over an impermeable layer 5 on a cylinder, then, by increasing the pressure, is shaped into a torus. During shaping of the carcass 4, certain parts undergo elongation and/or deformation of the order of 40% or more.

A crown 6, formed of various reinforcing elements, is attached to the shaped carcass: the crown reinforcements 6 which serve to reinforce the tire may conventionally include a plurality of superposed crossed plies, and optionally a hooping ply. They generally comprise metal reinforcement cords, in particular for the crossed plies, and/or textile reinforcement cords.

The tire blank is then finished by adding the various layers of mix constituting the tire, in particular the external tread.

The successive layers of mix, laid before and after shaping, may be of different natures; they are in particular made up of rubber or another elastomer, these being filled with silica and/or carbon black, with various additives, in particular comprising a vulcanization system.

Vulcanization, which is the final stage, then makes it possible to set the tire blank 1 in its definitive shape: it is then ready to be mounted on a rim 2.

It would of course be possible to attach measuring devices for instrumentation of the tire 1 to the rubber 7, or indeed to the rim 2. However, this solution can only apply to a few wheel parameters, and not to true measurements performed on the tire 1; furthermore, the adhesive bonding which is then necessary is not reliable in the long term.

True instrumentation of the tire 1 thus requires integration of the various devices before the last stage of vulcanization which ensures firm bonding between the various assembled layers and allows the material to develop its full mechanical capabilities. Furthermore, given that, when performed, the shaping stage involves considerable stresses, with modifications in size and shape, it may be preferable to integrate the electronic devices once the carcass 4 has been shaped. It is possible, however, by correctly dimensioning the geometry of the electrical wires (as will be specified further below), to set the instrumentation complex in place and then to shape the blank.

Instrumentation of a tire according to the invention entails implanting functional units in the tire blank, these being for example a sensor, and/or an electronic label for identifying the tire, and/or a monitoring device, as well as the electronic units associated with these entities. The sensor may extract a signal, be sensitive to a parameter or measure it: a force sensor, and/or a temperature sensor, and/or a pressure sensor etc. are possible. It is also feasible for one of these functional units to be an actuator, acting alone to modify and control a parameter or included in a regulation loop with a sensor.

In order to be powered and/or to deliver the measured data, a functional unit is conventionally connected to an antenna, often an electromagnetic antenna.

FIG. 2 is a schematic representation of a tire 10 comprising instrumentation included in the rubber, as known from the prior art. The functional unit, here a sensor 12, is designed to be controlled by an emitting device 14 external to the tire 10. The remote control may apply to the supply of power and/or communication of the parameters recorded. To this end, the sensor 12 is connected to an inductive receiving antenna 16 designed to be coupled electromagnetically to an emitting antenna 18 of the emitting device 14. The receiving antenna 16 is here formed of two loops comprising a conductive wire, but other configurations are possible. It may also be noted that, to cope with the deformations inherent in use of the tire, the antenna wires are arranged in undulating manner (other configurations are known) so as to be able to undergo the stresses to which the tire is subject, in particular the deformation thereof, without the risk of damage.

As has already been mentioned, this known instrumentation rapidly reaches its limits. In particular, the signal recorded has to be simple and capable of being transmitted directly to the control unit 14, or processing of the signal has to be performed directly in the sensor 12, which rules out any possibility of relocating processing to a site remote from the sensor, which is sometimes preferable, however.

Furthermore, it soon becomes clear that the number of sensors 12 has to remain restricted. However, it may prove desirable to measure a parameter at different places, distributed uniformly or non-uniformly over the circumference of the tire, or located in the sidewalls and the tread. In this case, for the sake of efficiency and reliability, it would seem desirable for processing of the signals to be performed by the same processing unit; for the sake of efficiency and in view of the number of antennas then necessary, this unit is not located outside the tire. An electrical connection is then recommended which consists of one or more electrical wires depending on the nature of the signal recorded and/or measured. This electrical connection has to face the same mechanical stresses as described above for the antennas and resulting from use of the tire.

Advantageously, the wires used for the electrical connection wiring are similar in nature to the wires used for the reinforcements for the crown 6 for example: such wires, often made of brass-coated steel, are known to be compatible and suitable for integration into tire mixes, while retaining good mechanical performance. However, their function here is to provide an electrical connection, with the features of resistivity and conductivity which that involves, and, as result of the insulation required, they are surrounded by an insulating elastomer.

In effect, another constraint placed on the electrical wiring stems from the very nature of the tire: composed of elastomers and/or rubbers filled with silica and carbon, it is slightly conductive. However, an electrical connection for signal transmission requires the electrical wires to be mutually insulated electrically and installed in an insulating environment.

The electrical wires of the connecting element according to the invention are integrated, in association with, that is to say integral with, a support, in such a way that no movement can occur at the interface between the wire and the support on elastic deformation of the latter. In the context of the invention, the conductors deform identically to the environment in which they are located, but the wires themselves, being inelastic, maintain a constant length. That is to say, when tensile force is applied to the support, the support may elongate without the wires putting up resistance, due to the geometry of the course they take; furthermore, at the interface, no displacement occurs between the surface of the wires and the surface of the support adjacent thereto. To increase adhesion, it is possible to perform treatment of the surface of the wires before embedding in the support.

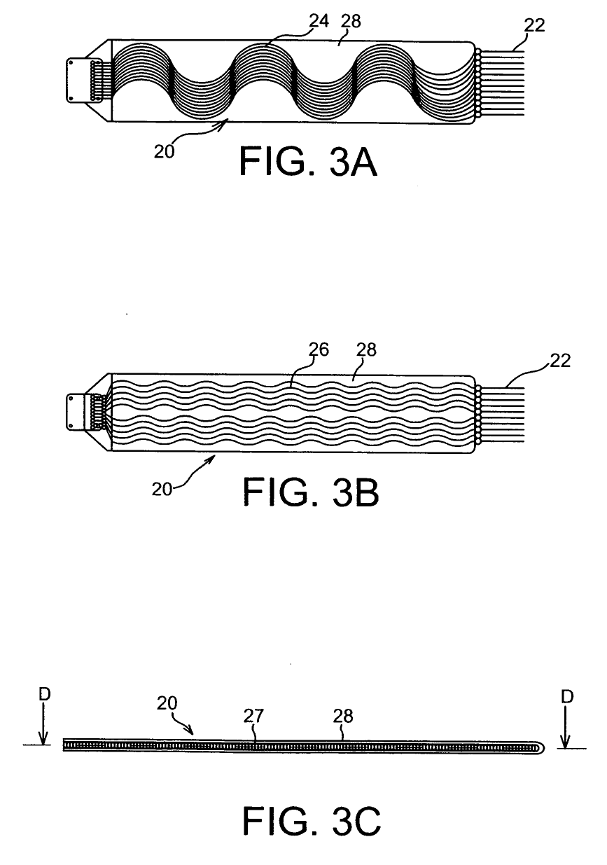

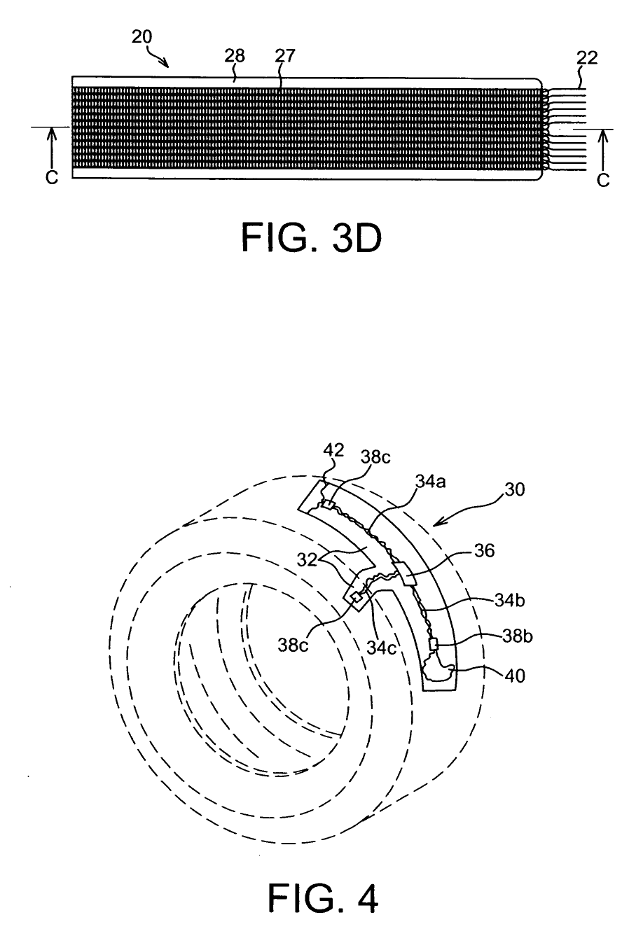

According to a preferred embodiment as illustrated in FIG. 3, the electrical connecting element 20 comprises a harness of electrical wires 22, which may vary in number, for example there may be twelve. The wires do not touch one another, so as to avoid any shearing between two wires on stretching thereof; it is thus desirable for each wire 22 to define a course parallel to its neighbor.

In one embodiment, the wires 22 are laid flat in an elastomer while exhibiting undulations. Depending on the amplitude of the undulations, it is possible to obtain a harness 24 with a geometry exhibiting broad undulations where each wire “fits into” another (see FIG. 3A) or a harness 26 with “undulating tracks” in which the wires exhibit undulations of small pitch, of low amplitude, along parallel courses, as in FIG. 3B. According to another embodiment, the wires 22 take the form of helicoidal windings 27, as illustrated in FIGS. 3C and 3D which show the same geometry in two different section planes. The choice of geometry depends in particular on the initial conductors (length, nature), on the process selected for achieving this geometry, and on the future implantation zone in the tire. In summary, it is preferable for each wire to follow a course having the appearance of sinusoids or of a succession of involutes to a circle, any shape without any rectilinear segment of finite length being preferred. Account is also taken of the tire manufacturing stage during which the harness is attached, so as to include the deformations which may result therefrom.

The harness may be integrated into an elastomer which takes the form of a ribbon cable 28: being generally quadrilateral, or even rectangular, in shape, and of small thickness, for example of the order of one millimeter or less, a connecting element 20 of this type may be easily set in place, in any position, during a tire manufacturing stage.

The elastomer in which the electrical harness is embedded is compatible with the rubber used for the tire: instrumentation of the tire makes only minimal modifications to the process of manufacturing the tire. In particular, the elastomer is capable of being vulcanized under the same conditions as the tire in which it is to be integrated. Furthermore, during this vulcanization, the electrical connecting element 20 becomes integral with the rest of the tire: the elastomer of the support 28 is compatible with the mix on which it is placed and with the mix which covers it, such that the polymer chains become interwoven when the temperature rises. At the end of the process, just as the various layers of mix are intimately bonded to one another in a commercial tire, the polymer can no longer be dissociated from its surroundings, forming intimately interwoven crosslinking.

Furthermore, the electrical connecting element 20 is precured, that is to say pre-crosslinked, or pre-vulcanized, before being integrated into the tire blank: it turns out that the start of crosslinking of the elastomer ensures integration and complete fixing of the wires 22 of the harness inside the support 28. This makes it possible to shape the geometry of the element 20: in fact, some of the polymeric bonds have been established, such that the material of the support 28 has left a purely plastic state, even if it does not enjoy the optimum mechanical properties achieved during vulcanization. Thanks to this first pre-crosslinking of the elastomer, it is also possible to ensure upstream, for example in a laboratory, that the element 20 is not defective and fulfils the conditions for instrumentation not damaging to the properties of the tire.

The harnesses such as illustrated in FIG. 3 exhibit two ends forming a galvanic connection, and which may connect between them two functional units. Solely by way of example, two configurations of the ends are shown, but it is clear that any configuration is feasible, and that it depends in particular on the functional unit which is to be connected thereto.

For better reliability and to simplify integration into the tire, or any other deformable article used for the ground contact system of a vehicle, it is furthermore desirable for the functional units connected to each of the ends also to be embedded in the elastomer constituting the ribbon cable 28. In effect, even if it is feasible to produce the electrical connections between electrical harness and functional unit during positioning of the connecting element on the tire blank, it is preferable to attach thereto, during assembly of the various constituents of the tire, a pre-prepared complex comprising the majority, or even all, of the instrumentation intended therefor. Advantageously, this instrumentation complex may be prepared somewhere other than the tire production lines, for example in a more controlled environment, or even in a laboratory.

As with the harness, it is desirable for the complex then to be of a shape which may be integrated into the tire during building thereof, in particular flat. The complex may itself be shaped into a toroidal shape, covering the entire radial surface and a lateral surface of the carcass 4.

A complex 30 according to the invention is shown in FIG. 4: it is shaped for instrumentation of the tire casing shown with broken lines. It comprises a support 32 which gives it its shape. The support 32 is formed of an elastomer as described above: compatible with the rubber of the tire, it has additionally been pre-crosslinked and pre-shaped so as to obtain a shape which adapts easily to the torus illustrated schematically. The support 32 is composed, for example, entirely of an insulating elastomer, so as to prevent electrical interference from distorting the sensor signals. It may have been manufactured by locating and integrating the various elements in an uncured polymer, then proceeding with pre-vulcanization.

In the illustration, the complex comprises three harnesses 34 forming the interconnect systems of the complex 30. These harnesses are composed of a variable number of wires, there being no need for the wiring assemblies 34a, 34b, 34c to have the same number of wires, nor the same geometry; in particular, the harness 34c which is attached to the sidewall undergoes stresses of a different nature from the other two. The wires of each harness have a geometry which enables them to undergo elongation, for example such as in FIG. 3. The harnesses are each connected at one of their ends to a functional processing and control unit 36.

At their other end, each of the electrical wires is connected to three other functional units 38. The two units 38a and 38b may for example be sensors, which are additionally connected to emitting or receiving antennas: the sensor 38b is connected to an electromagnetic antenna 40, the sensor 38a to two radiofrequency antennas 42. The third harness 34c is connected to an actuator 38c: as a function of the data transmitted by the sensors 38a and 38b to the unit 36, the unit 36 indicates to the actuator 38c to apply stress to the sidewall of the tire on which it is mounted.

The group of elements 34, 36, 38, 40, 42 is integrated into the support 32 so as not to undergo relative displacement with regard to the elastomer at any contact point when tensile force and/or compression is exerted on the support 32. Since the support 32 is itself made of a material compatible with the rubber of the tire, such that the tire and the support 32 constituting the outside of the complex 30 are fully linked together, no relative movement occurs between the instrumentation complex 30 and the tire at the level of its interface, and thus shearing does not alter the properties of the tire. It is possible to have a support 32 of heterogeneous nature, as long as the material thereof remains compatible with the rubber, for example by providing the elastomer with a local filling of conductive particles in the vicinity of the antennas 40, 42.

It is clear that this example is given by way of illustration: it is possible to have a different number of sensors, the presence of an actuator on the sidewall is not obligatory, the antennas are optional, or may be located on other functional units from all the sensors, the shape of the complex may be different, e.g. originating solely from the tread etc.

For manufacture, for example, the impermeable layer and various building layers are laid on a suitable manufacturing support. After shaping of the carcass into a torus and positioning of some at least of the crown ply, the complex 30 is placed directly on the assembly thus formed, between two crown block products. Preparation of the blank then continues normally, with in particular positioning of the tread. Final vulcanization allows formation of the tire incorporating the complex 30.

It is also possible for shaping of the tire to take place once the instrumentation complex is already in place, for example if certain sensors have to be located beneath, or at the level of, the carcass ply. In this case, the dimensions of the complex 30 are selected so as to cope with deformations which may for example reach 70%, stemming both from the manufacture of the tire and use thereof. It should be noted that shaping is of course not indispensable for manufacture of an instrumented tire.

It may thus be noted that structural elongation for an instrumentation complex of one and the same tire may be selected to be of the order of 20 to 40% or between 40 and 70% depending on use thereof during manufacture of the tire.

The tire resulting from the manufacturing process thus comprises instrumentation integrated within the volume thereof. In particular, the electrical connections are such that the electrical wires do not undergo any movement relative to the rubber of the tire during use thereof, at the level of the interface between the various materials.

1. An electrical connecting element (20) designed to be incorporated in a deformable article used for the ground contact system of a vehicle, said element comprising a support (28, 32) and an electrical harness (24, 26, 34), which comprises at least one electrical wire (22) capable of establishing a galvanic connection between its two ends, the support (28, 32) consisting substantially of an elastomer which is pre-crosslinked, in which the electrical harness (24, 26, 34) is rendered integral with the support (28, 32) such that, at the interface, no relative displacement is able to take place between the surface of each wire (22) and the adjacent surface of the support (28, 32), and in which the course taken by the wires (22) in the support (28, 32) is non-linear such that the support (28, 32) may undergo elongation without the wires (22) putting up any resistance.

2. The electrical connecting element according to claim 1, in which the elastomer is insulating.

3. The electrical connecting element according to claim 1, in which the harness (24, 26, 34) comprises a plurality of electrical wires.

4. The electrical connecting element according to claim 3, in which the wires of the harness (22) take parallel courses.

5. The electrical connecting element according to claim 1, in which each wire (22) forms undulations (24, 26) within the support.

6. The electrical connecting element according to claim 1, in which each wire (22) takes the form of a helicoidal winding (27).

7. The electrical connecting element according to claim 1, in which the harness (24, 26, 27, 34) consists of wires of brass-coated steel.

8. The electrical connecting element according to claim 1, in which the support (28, 32) exhibits a thickness of the order of one millimeter.

9. A semi-finished instrumentation complex (30) used in manufacture of a rubber article for the ground contact system of a vehicle, said complex comprising at least one electrical connecting element (20) according to claim 1 and functional units (36, 38) connected to the ends thereof.

10. The complex (30) according to claim 9, comprising a plurality of the electrical connecting elements connected at one end to one and the same functional unit (36).

11. The complex according to claim 9, in which one functional unit (36) is a processing unit capable of transmission and/or control.

12. The complex according to claim 9, in which one functional unit (38) is a sensor or an actuator.

13. The complex according to claim 9, comprising at least one antenna (40, 42) connected to a functional unit (38).

14. The complex according to claim 9, in which the support (32) of the electrical connecting element (20) has the entire complex (30) embedded therein, such that none of the elements (34, 36, 38, 40, 42) constituting the complex (30) undergoes relative displacement with regard to the support (32) at the level of the interface in the event of the support being subjected to tensile stress.

15. A process for manufacturing an instrumented rubber article for the ground contact system of a vehicle, comprising the following steps:
setting in place on a suitable manufacturing support at least a first constituent of said rubber article for the ground contact system of a vehicle to form a first assembly;
setting in place a connecting element (20) according to claim 1 on the first assembly to form a second assembly;
setting in place a second constituent on the second assembly to form a blank of this rubber article for the ground contact system of a vehicle; and
vulcanizing the blank.

16. The manufacturing process according to claim 15 used for the manufacture of a tire and further comprising a stage involving shaping of the first assembly.

17. The process for manufacturing an instrumented tire according to claim 16, further comprising a stage involving shaping of the second assembly during which the surface of the electrical wire(s) (22, 34) of the harness do(es) not undergo any displacement relative to the directly adjacent surface of the support (28, 32) thereof.

18. The tire comprising an electrical connecting element, comprising at least one electrical wire, integrated (34) such that each electrical wire does not undergo any relative displacement with regard to the rubber of the tire at the level of the interface between wire and rubber.

19. The tire according to claim 18, in which the rubber adjoining the electrical wires (34) is electrically insulating.

20. The tire according to claim 18, comprising integrated functional units (36, 38) which are connected to the electrical connecting element (34).

21. A process for manufacturing an instrumented rubber article for the ground contact system of a vehicle, comprising the following steps:
setting in place on a suitable manufacturing support at least a first constituent of said rubber article for the ground contact system of a vehicle to form a first assembly;
setting in place an instrumentation complex (30) according to claim 9 on the first assembly to form a second assembly;
setting in place a second constituent on the second assembly to form a blank of this rubber article for the ground contact system of a vehicle; and
vulcanizing the blank.

22. The manufacturing process according to claim 21 used for the manufacture of a tire and further comprising a stage involving shaping of the first assembly.

23. The process for manufacturing an instrumented tire according to claim 22, further comprising a stage involving shaping of the second assembly during which the surface of the electrical wire(s) (22, 34) of the harness do(es) not undergo any displacement relative to the directly adjacent surface of the support (28, 32) thereof.
